(19) United States
(12) Patent Application Publication
(10) Pub. No.: US 2023/0005227 A1
(43) Pub. Date: Jan. 5, 2023

(54) ELECTRONIC DEVICE AND METHOD FOR OFFERING VIRTUAL REALITY SERVICE

(71) Applicant: Samsung Electronics Co., Ltd., Suwon-si (KR)

(72) Inventors: Myungkyu KIM, Suwon-si (KR); Insik MYUNG, Suwon-si (KR); Donghee KANG, Suwon-si (KR); Yeeun CHOI, Suwon-si (KR); Hoon HAN, Suwon-si (KR); Taehun KO, Suwon-si (KR); Yonghee CHO, Suwon-si (KR)

(21) Appl. No.: 17/942,565

(22) Filed: Sep. 12, 2022

Related U.S. Application Data
(63) Continuation of application No. PCT/KR2021/016232, filed on Nov. 9, 2021.

(30) Foreign Application Priority Data
Nov. 9, 2020 (KR) 10-2020-0148711

(51) Int. Cl. G06T 19/00; G06T 7/70; G06V 20/20

(52) U.S. Cl. CPC G06T 19/006; G06T 7/70; G06V 20/20; H04N 5/247

(57) ABSTRACT

An electronic device may include a communication module, a camera, and at least one processor operably coupled with the communication module and the camera. The at least one processor may be configured to establish a communication connection with an external device and a wearable device by using the communication module, and acquire an image through the camera, and acquire first object information for rendering a first virtual reality object based on the image, and transmit the first object information to the external device through the communication module, and while transmitting the first object information to the external device, determine whether a specified event occurs, and provide map information on a peripheral environment of the electronic device based on at least one of first peripheral space information including information on an object located within a first region, acquired by using the camera, or second peripheral space information including information on an object located within a second region, received from the wearable device, and based on the occurrence of the specified event, transmit second object information which includes the map information and information on a location of the first virtual reality object within the map information, to the external device.

### CROSS-REFERENCE TO RELATED APPLICATIONS

This application is a continuation of International Application No. PCT/KR2021/016232 designating the United States, filed on Nov. 9, 2021, in the Korean Intellectual Property Receiving Office and claiming priority to Korean Patent Application No. 10-2020-0148711 filed on Nov. 9, 2020, the disclosures of which are incorporated by reference herein in their entireties.

### BACKGROUND

### Field

Various embodiments of the present disclosure relate to an electronic device and/or method for offering a virtual reality object.

### Description of Related Art

Research and development for an augmented reality (AR) function and its use are increasing. Augmented reality can be a technology for synthesizing virtual related information (e.g., a text, an image, etc.) to a real thing (e.g., a real environment) and showing. Augmented reality can, unlike virtual reality (VR) aiming at only a virtual space and thing, provide a virtual object on an object called a real environment. Virtual reality can be a virtual space which is implemented to have a similar experience with reality with respect to the virtual space and a virtual thing. Mixed reality (MR) can mean a space which is made by combining and merging virtual information and reality information.

To provide virtual and/or augmented reality contents, a camera of an electronic device can acquire a rendering image continuously tracking a user who is a subject which is a photographing target and reflecting a location, look or/and direction, etc. of the user. In this case, because the camera included in the electronic device has a restricted angle range of view (e.g., general angle (standard angle), wide angle or narrow angle (e.g., telescope angle)), there is a limit in tracking a location, look and/or direction, etc. of the user, when the user moves.

### SUMMARY

Various example embodiments can offer a technique/method for setting various events capable of occurring when a virtual realty service is used by using an electronic device and a wearable device, and offering virtual and/or augmented reality contents wherein the virtual reality service can be seamlessly smoothly used by using peripheral space information of a user, and an electronic device supporting the same.

In accordance with various example embodiments of the present disclosure, an electronic device can include a communication module comprising communication circuitry, a camera, and at least one processor (comprising processing circuitry) operably coupled with the communication module and the camera. The at least one processor can be configured to establish a communication connection with an external device and a wearable device using the communication module, and acquire an image through the camera, and acquire first object information for rendering a first virtual reality object based on the image, and transmit the first object information to the external device through the communication module, and while transmitting the first object information to the external device, determine whether a specified event occurs, and acquire map information on a peripheral environment of the electronic device based on at least one of first peripheral space information including information on an object located within a first region, acquired using the camera, or second peripheral space information including information on an object located within a second region, received from the wearable device, and based on the occurrence of the specified event, transmit second object information which includes the map information and information on a location of the first virtual reality object within the map information, to the external device.

An operation method of an electronic device of various example embodiments can include establishing a communication connection with an external device and a wearable device using a communication module comprising communication circuitry, and acquiring an image through a camera, and acquiring first object information for rendering a first virtual reality object based on the image, and transmitting the first object information to the external device through the communication module, and while transmitting the first object information to the external device, determining whether a specified event occurs, and acquiring map information on a peripheral environment of the electronic device based on at least one of first peripheral space information including information on an object located within a first region, acquired using the camera, or second peripheral space information including information on an object located within a second region, received from the wearable device, and based on the occurrence of the specified event, transmitting second object information which includes the map information and information on a location of the first virtual reality object within the map information, to the external device.

According to an example embodiment, although a user who takes part in a call using an augmented reality service or a virtual realty service gets out of a range of view angle of a camera included in an electronic device, the electronic device can offer virtual or/and augmented reality contents in order to smoothly proceed with the call which uses the augmented realty service or virtual reality service, and increase an activity scope of the user.

Also, according to an example embodiment, a rendering image representative of the user and/or a rendering image including information on the user and a peripheral space around the user can be offered as virtual and/or augmented reality contents according to context related to the call which uses the augmented reality service or virtual reality service.

Besides this, various effects taken directly or indirectly through the present document can be offered.

### BRIEF DESCRIPTION OF DRAWINGS

In relation to the description of the drawings, the same or similar reference numerals may be used with respect to the same or similar elements. Additionally, the above and other aspects, features and advantages of certain embodiments of the present disclosure will be more apparent from the following detailed description, taken in conjunction with the accompanying drawings, in which:

FIG. 1 is a block diagram of an electronic device within a network environment according to various embodiments.

FIG. 2 is a diagram illustrating a system including an electronic device performing a call which uses a virtual reality service or augmented reality service according to an embodiment.

FIG. 3 illustrates a hardware construction of an electronic device and a wearable device according to an embodiment.

FIG. 4 is an operation ladder diagram of devices offering virtual reality contents according to an embodiment.

FIG. 5 is a flowchart for explaining an electronic device offering virtual reality contents according to an embodiment.

FIG. 6 illustrates a screen illustrating conversion from a video call function of an electronic device to a three-dimension virtual video conference function according to an embodiment.

FIG. 7 illustrates a region capable of tracking using an electronic device and a wearable device according to an embodiment.

FIG. 8 is a diagram illustrating a state of a first user and the occurrence of a specified event dependent on this according to various embodiments.

FIG. 9A illustrates an image which is acquired using an electronic device in a first state of a first user according to an embodiment.

FIG. 9B illustrates a rendered object which is offered through a wearable device according to an embodiment.

FIG. 10 is a flowchart for explaining an electronic device offering virtual reality contents according to an embodiment.

FIG. 11A illustrates an image which is acquired using an electronic device in a second state of a first user according to an embodiment.

FIG. 11B illustrates a rendered object which is offered through a wearable device according to an embodiment.

FIG. 12A illustrates an image which is acquired using an electronic device in a third state of a first user according to an embodiment.

FIG. 12B illustrates a rendered object which is offered through a wearable device according to an embodiment.

FIG. 13A illustrates an image which is acquired using an electronic device in a fourth state of a first user according to an embodiment.

FIG. 13B illustrates a rendered object which is offered through a wearable device according to an embodiment.

FIG. 14A illustrates a tracking state of a portion of a body of a first user who uses a wearable device according to an embodiment.

FIG. 14B illustrates a rendered object which is offered through a wearable device according to an embodiment.

FIG. 15A illustrates a tracking state of a portion of a body of a first user who uses a wearable device according to an embodiment.

FIG. 15B illustrates a rendered object which is offered through a wearable device according to an embodiment.

FIGS. 16A and 16B illustrate an example of a virtual reality object which is offered through a wearable device according to an embodiment.

FIG. 17 illustrates a condition in which a first user moves within and without a range of view angle of a camera of an electronic device according to an embodiment.

FIG. 18 is a flowchart for explaining an electronic device offering a virtual reality object according to an embodiment.

Any of the embodiment(s) described herein may be used in conjunction with any other embodiment(s) described herein.

### DETAILED DESCRIPTION

Various example embodiments of the present disclosure are mentioned below with reference to the accompanying drawings. However, these do not intend to limit the present disclosure to a specific embodiment form, and it should be understood to include various modifications, equivalents and/or alternatives of an embodiment of the present disclosure.

Throughout the present document, for a description convenience's sake, it can be mentioned that the term ‘virtual reality’ is a concept including augmented reality (AR), virtual reality (VR), and mixed reality (MR).

Any of the embodiment(s) described herein may be used in conjunction with any other embodiment(s) described herein.

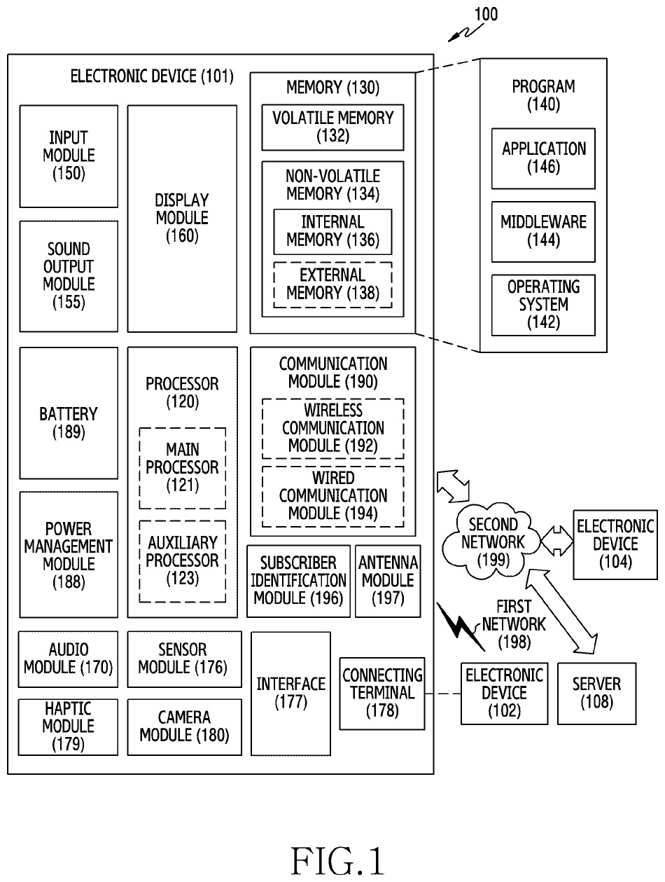

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150 comprising input circuitry, a sound output module 155 comprising output circuitry, a display module 160 comprising display circuitry, an audio module 170 comprising audio circuitry, a sensor module 176 comprising sensing circuitry, an interface 177, a connecting terminal 178, a haptic module 179, a camera module 180 comprising camera circuitry, a power management module 188, a battery 189, a communication module 190 comprising communication circuitry, a subscriber identification module (SIM) 196, or an antenna module 197 comprising an antenna(s). In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120, comprising processing circuitry, may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Any processor described herein may comprise processing circuitry.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 (comprising input circuitry) may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 (comprising communication circuitry) may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 (comprising communication circuitry) may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 (comprising at least one antenna and/or circuitry) may transmit or receive a signal or power to or from the outside (e.g., the external electronic device) of the electronic device 101. According to an embodiment, the antenna module 197 may include an antenna including a radiating element of or including of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various example embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In various example embodiments, content explained for a construction or function of the electronic device 100 can be applied even to the wearable device 102, a wearable device 106, and the external device 104 (e.g., see FIGS. 1-4).

The electronic device according to various example embodiments may be one of various types of electronic devices. The electronic devices may include, for example, a portable communication device (e.g., a smartphone), a computer device, a portable multimedia device, a portable medical device, a camera, a wearable device, and/or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various example embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

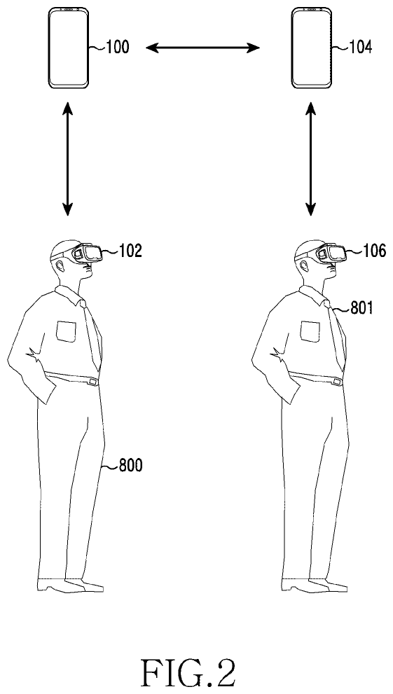

FIG. 2 is a diagram illustrating a system including the electronic device 100 performing a call which uses a virtual reality service or augmented reality service according to an example embodiment.

The electronic device 100 can offer virtual and/or augmented reality contents wherein people who are located in respectively different spaces can gather in a virtual conference room and proceed with a three-dimensional virtual video conference. The three-dimension virtual video conference is a service of connecting a plurality of electronic devices and offering each of an augmented reality object and/or a virtual reality object to at least one of users of the plurality of electronic devices. For example, the users who are to participate in the three-dimension virtual video conference which uses an augmented reality technology can wear a wearable device (e.g., a head mounted display (HMD) device) or smart glass, and obtain information on a state of the user such as a location and/or direction of the user using the electronic device and the wearable device. A rendering image representative of the user can be acquired based on the information on the user state such as a location, direction and/or gesture of the user, and virtual and/or augmented reality contents can be offered based on the rendering image.

In an embodiment, the electronic device 100 can include a station or home server offering a virtual reality (VR), augmented reality (AR) or mixed reality (MR) service or an arbitrary electronic device having a suitable processing capability.

In an example embodiment, the electronic device 100 is a device capable of offering a three-dimension virtual video conference function. The three-dimension virtual video conference function means a function of offering an augmented reality object or a virtual reality object wherein a user who is in a mutually different space can proceed with a call which uses the virtual reality service, through the virtual reality object outputted through the wearable device. In an example, the electronic device 100 can offer contents on the virtual reality object outputted through the wearable device 102. For example, the contents on the virtual reality object can include information for rendering the virtual reality object (e.g., information on a subject of the user and/or object information included in a peripheral environment space).

In an embodiment, the electronic device 100 can be connected with the wearable device 102 and/or the external device 104 through a network.

In an example embodiment, the wearable device 102 can include a head mounted display (HMD) device, a smart glass or a terminal device. However, this is merely illustrative, and the present disclosure is not limited to this. In an example, the wearable device 102 can be fixed to a facial side of a first user 800 who participates in the three-dimension virtual video conference.

In various example embodiments, the external device 104 can perform the same function as the electronic device 100.

In an example embodiment, the wearable device 106 can be a device performing the same function as the wearable device 102. In an example, the wearable device 106 can be fixed to a facial side of another or second user 801 who participates in the three-dimension virtual video conference.

In an example embodiment, a three-dimension virtual reality object can be outputted by the wearable device 102 and the wearable device 106.

The system illustrated in FIG. 2 is for explaining an example embodiment, and a system of an example embodiment can omit some of the components illustrated in FIG. 2 or be replaced with other components. For example, the electronic device 100 and the wearable device 102 can be replaced with one device capable of performing all functions of the two devices as well. For another example, the external device 104 and the wearable device 106 can be replaced with one device as well.

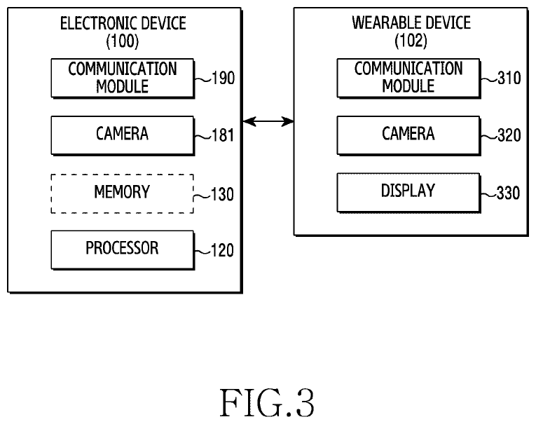

FIG. 3 illustrates a hardware construction of the electronic device 100 and the wearable device 102 according to an example embodiment.

Referring to FIG. 3, the electronic device 100 can include at least one processor 120, the communication module 190 comprising communication circuitry, and/or a camera 181 (e.g., a camera included in the camera module 180 of FIG. 1). However, the construction of the electronic device 100 is not limited to this. According to various embodiments, the electronic device 100 can further include at least one another component besides the aforementioned components. For example, the electronic device 100 can further include the memory 130 and/or a display module (e.g., the display module 160 of FIG. 1).

In an embodiment, the electronic device 100 can offer a photographing function using the camera 181. The camera 181 can capture a still image and a moving image. The electronic device 100 can photograph an object corresponding to the first user 800 who wears the wearable device 102. In an example, the electronic device 100 can recognize a portion (e.g., an upper half of a body including a face, hands and/or arms) of the body of the first user 800 who wears the wearable device 102 using the camera 181, and track the recognized portion of the body.

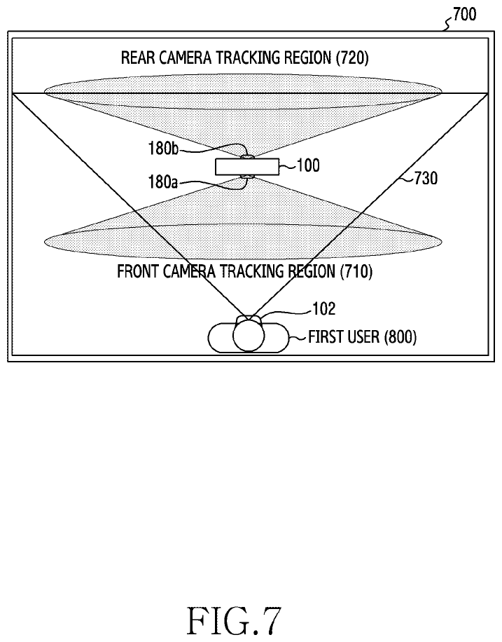

According to an example embodiment, the camera 181 of the electronic device 100 can include a plurality of cameras. The plurality of cameras can be disposed in at least one surface of a housing of the electronic device 100. For example, a front camera 180a among the plurality of cameras can be disposed in a front surface of the housing, and a rear camera 180b being another at least one of the plurality of cameras can be disposed in a rear surface of the housing (e.g., see FIG. 7).

In an example embodiment, the camera 181 can use at least one of an image sensor, an RGB camera, an infrared camera, and a depth camera (e.g., a time of flight (ToF) camera and a structured light (SL) camera).

In an example embodiment, the communication module 190 can support communication between the electronic device 100 and the external electronic device (e.g., the wearable device 102 and/or the external device 104). For example, the communication module 190 can establish wireless communication of a regulated communication protocol with the external electronic device, and transmit and/or receive a signal or data using a frequency band which supports the wireless communication. The wireless communication, for example, can include at least one of ultra-wideband (UWB) communication, WiFi communication, WiGig communication, Bluetooth (BT) communication, or Bluetooth low energy (BLE) communication.

In an embodiment, the memory 130 can store various data which are used for at least one component of the electronic device 100. According to an embodiment, the memory 130 can store a process executed by the processor 120 or data or an instruction used by an application program.

According to an embodiment, the memory 130 can store information on a photographed subject. In an example, the information on the photographed subject can include data photographing the subject as a still image and/or a moving image. In an example, the information on the photographed subject can include data changing or processing the data photographing the subject as the still image and/or the moving image.

In an embodiment, the processor 120 can control at least one another component of the electronic device 100, and can perform various data processing or operations. In an embodiment, the processor 120 can perform an instruction for controlling operations of the camera 181, the communication module 190, the memory 130, and/or the display module 160.

In an embodiment, the processor 120 can acquire an image through the camera 181. In an example, the image can include an object corresponding to the first user 800 who wears the wearable device 102. In an example, the processor 120 can recognize a portion (e.g., an upper half of a body including a face, hands and/or arms) of the body of the first user 800 using the camera 181, and track the portion of the body of the first user 800. The processor 120 can acquire information tracking the portion of the body of the first user 800 from the image acquired through the camera 181. For example, the processor 120 can recognize and track eyes, a nose, and/or a mouth of the first user 800 using the camera 181. In this case, the processor 120 can acquire information on a change of a mouth shape and/or information on a movement of eyebrows, from the image. For example, the processor 120 can recognize and track hands and arms of the first user 800 using the camera 181. In this case, the processor 120 can acquire information on a movement of the hands, information on a movement of fingers and/or information on a movement of an arm motion, from the image.

In an embodiment, the processor 120 can acquire first peripheral space information of the electronic device 100 through the camera 181. In an example, the first peripheral space information can be acquired using the front camera 180a and/or the rear camera 180b of the camera 181. The first peripheral space information can include information on a peripheral space around the electronic device 100. For example, the first peripheral space information can include information on an object (or a thing) (e.g., furniture, person, and/or any other object) disposed in the peripheral space around the electronic device 100 (e.g., information on at least one of a location, form or size of the object).

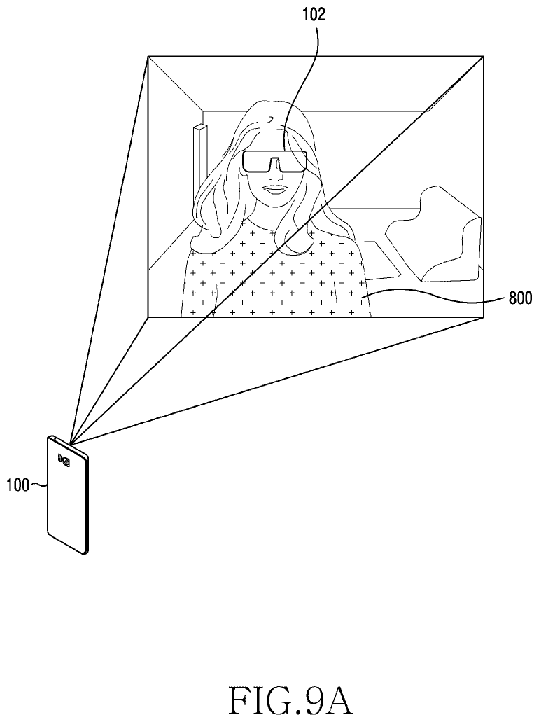

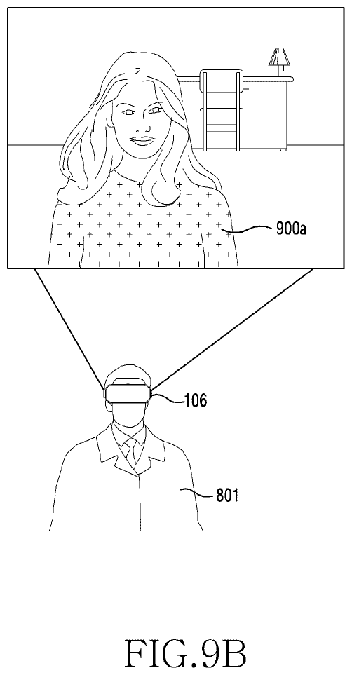

In an embodiment, the processor 120 can acquire first object information which includes information for rendering an object corresponding to the first user 800 as a first virtual reality object (e.g., a first virtual reality object 900a of FIG. 9B), based on the image acquired through the camera 181. In an example, the first object information can include information on the object corresponding to the first user 800 and/or information tracking a portion of a body of a subject corresponding to the first user 800. For example, the first object information can include at least one of information on a facial look of the first user 800, or gesture information on hands of the first user 800.

In an example embodiment, the processor 120 can transmit the first object information to the external device 104 through the communication module 190. In an example, the external device 104 can render the first virtual reality object 900a based on the received first object information. The wearable device 106 connected with the external device 104 can output the rendered first virtual realty object 900a. For example, the processor 120 can render a virtual image corresponding to information on a facial look included in the first object information, or render a virtual image corresponding to gesture information included in the first object information. According to an embodiment, the first object information can include information for rendering a virtual reality object or an augmented reality object in a mode (below, a face to face mode) in which a face of a user is expressed relatively in detail).

In an example embodiment, the processor 120 can acquire map information on a peripheral environment of the electronic device 100 based on the first peripheral space information acquired through the camera 181 and/or first peripheral space information acquired through the wearable device 102. In an example, the second peripheral space information acquired through the wearable device 102 can include information on a region not included in the first peripheral space information. The map information may signify information on a location or shape of an object(s) disposed around the electronic device 100. For example, the map information can include a coordinate value which indicates at least one of a distance or direction in which an object(s) is located with criterion of a location of the electronic device 100.

In an embodiment, the processor 120 can determine whether a specified event has occurred while transmitting the first object information to the external device 104.

In an example, in response to the specified event occurring, the processor 120 can acquire second object information which includes the map information and information on a location of the first virtual reality object 900a within the map information. In an example, the second object information can include information on a coordinate indicating the location of the first virtual reality object 900a within the map information, and/or a relative location between a peripheral space object included in the map information and the first virtual reality object 900a.

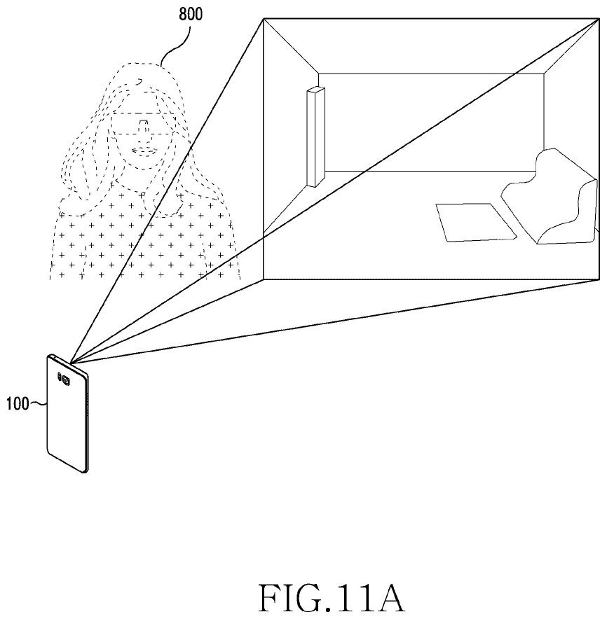

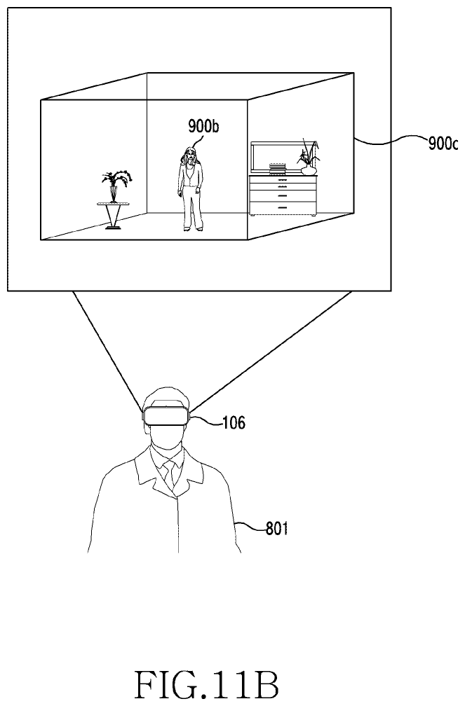

In an embodiment, the processor 120 can transmit the second object information to the external device 104. In an example, the external device 104 can render a second virtual reality object (e.g., a second virtual reality object 900b of FIG. 11C) and a virtual reality space (e.g., a virtual reality space 900c of FIG. 11C) based on the received second object information. In an example, the wearable device 106 connected with the external device 104 can output the rendered second virtual reality object 900b and virtual reality space 900c.

According to an example embodiment, the second object information can include information on a virtual space and information on the first user 800 within the virtual space. According to an example, in comparison to the first object information, the second object information can further include information on a peripheral space around the first user 800, and exclude information on a look of the first user 800. The second object information can include information for rendering a virtual reality object or augmented reality object in a mode (below, a miniature mode) in which a virtual space and a user within the virtual space are relatively simply expressed.

Referring to FIG. 3, the wearable device 102 can include a communication module 310, a camera 320, and/or a display 330. However, the construction of the wearable device 102 is not limited to this.

In an example embodiment, the wearable device 102 can be a head mounted electronic device.

In an embodiment, a lens portion (not shown) including a plurality of lenses can be disposed in the wearable device 102, and a user can view an image displayed on the display 330 through the lens portion. In an example, the wearable device 102 can implement a virtual and/or augmented reality within a virtual three-dimension space through a left-eye image and a right-eye image. In an example, the wearable device 102 can output a virtual reality object within the three-dimension space.

In an embodiment, the first user 800 who wears the wearable device 102 can view a virtual reality object corresponding to another second user 801 who uses a virtual reality service, through the wearable device 102. Below, the wearable device 102 and the wearable device 106 can operate mutually complementarily.

The wearable device 102 can include at least one sensor for acquiring facial look information of the first user 800 who wears the wearable device 102, information on a head movement and/or a hand motion movement, and/or information on a leg movement. The wearable device 102 can acquire sensor information through the at least one sensor. The first object information and/or the second object information can include the sensor information acquired through the wearable device 102. In an embodiment, the wearable device 102 can acquire the second peripheral space information of the first user 800 who wears the wearable device 102, by using the camera 320. In an example, the second peripheral space information can include information on a peripheral space around the first user 800 and information (e.g., information expressed in a coordinate form) on a location of the first user 800 in the peripheral space around the first user 800.

In an embodiment, the camera 320 can use at least one of an image sensor, an RGB camera, an infrared camera, and a depth camera (e.g., a time of flight (ToF) camera and a structured light (SL) camera).

A connection relationship between hardware illustrated in FIG. 3 is for description convenience's sake, and does not limit a flow/direction of data or a command. The components included in the electronic device 100 and the wearable device 102 can have various electrical and/or operable connection relationships.

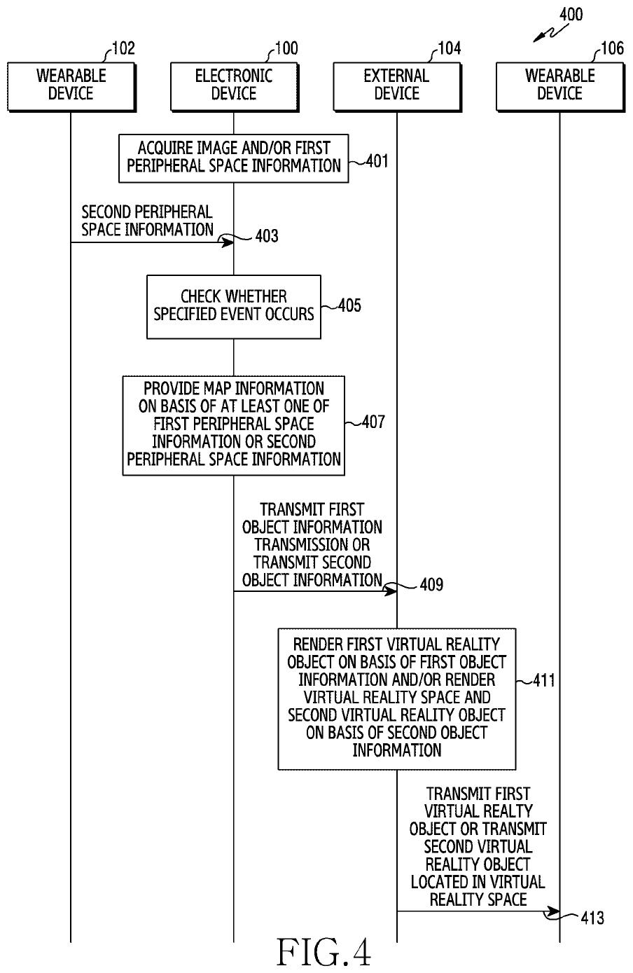

FIG. 4 is an operation ladder diagram 400 of devices which offer virtual reality contents according to an example embodiment.

In an embodiment, prior to operation 401, the first user 800 can mount the electronic device 100 wherein a front surface of the camera 181 faces a self.

In an embodiment, prior to operation 401, the processor 120 of the electronic device 100 can connect communication with the external device 104 and/or the wearable device 102 using the communication module 190. For example, the electronic device 100 can transmit call-signaling for connecting a phone call to the external device 104 and, in response to the external device 104 accepting the call-signaling, the phone call can be connected between the electronic device 100 and the external device 104.

In an embodiment, prior to operation 401, the processor 120 of the electronic device 100 can drive at least one camera 181 included in the electronic device 100.

According to an embodiment, the processor 120 of the electronic device 100 can, in operation 401, acquire an image and/or first peripheral space information using the camera 181. In an example, the image can include an object corresponding to the first user 800 who wears the wearable device 102. In an example, the image can include information tracking a portion (e.g., an upper half of a body including a face, hands or arms) of the body of the first user 800 who wears the wearable device 102.

In an example, the first peripheral space information can include information on a peripheral space within a range of view angle of the camera 181. In an example, the first peripheral space information can include information on an object located in a first region, acquired using the camera 181. In an example, the first region can be a peripheral space region around the electronic device 100. In an example, the first peripheral space information can include information on an object disposed in a peripheral space around the electronic device 100 (e.g., information on at least one of a location, form or size of the object).

In an example, the processor 120 can acquire the first object information which includes information for rendering the first virtual reality object 900a based on the image.

According to an embodiment, the processor 120 of the electronic device 100 can, in operation 403, receive second peripheral space information from the wearable device 102. In an example, the wearable device 102 can acquire the second peripheral space information using the camera 320. In an example, the wearable device 102 can acquire the second peripheral space information which includes information on a peripheral space around the first user 800 who wears the wearable device 102, using at least one camera 320. In an example, the electronic device 100 can receive the second peripheral space information which includes information on an object located in a second region from the wearable device 102. In an example, the second region can be a peripheral region around the first user 800 who wears the wearable device 102. In an example, the second peripheral space information can include information on an object disposed in a peripheral space around the first user 800 (e.g., information on at least one of a location, form or size of the object). In an example, the second peripheral space information can include information on a region not included in the first peripheral space information.

According to an embodiment, the processor 120 of the electronic device 100 can, in operation 405, determine whether a specified event has occurred. In an example, the processor 120 of the electronic device 100 can determine whether the specified event has occurred while the processor 120 transmits the first object information to the external device 104.

According to an embodiment, the processor 120 of the electronic device 100 can, in operation 407, acquire map information using the first peripheral space information and/or the second peripheral space information. The map information can include information on objects disposed in the peripheral space.

According to an embodiment, in response to the specified event having not occurred, the processor 120 of the electronic device 100 can, in operation 409, transmit the first object information to the external device 104.

According to an embodiment, in response to the specified event having occurred, the processor 120 of the electronic device 100 can, in operation 409, transmit the second object information to the external device 104. In an example, the second object information can include the map information and information on the first virtual reality object 900a associated with the map information. For example, the second object information can exclude information on a facial look of the first user 800 corresponding to the first virtual reality object 900a. The information on the first virtual reality object 900a associated with the map information can include information (e.g., information expressed in a coordinate form) on a location on the map information of the first virtual reality object 900a.

According to an embodiment, the external device 104 can, in operation 411, render a virtual reality object based on the received first object information or second object information. In an example, the external device 104 can render the first virtual reality object 900a using the received first object information. The external device 104 can render the second virtual reality object 900b and the virtual reality space 900c using the received second object information and map information.

According to an embodiment, the external device 104 can, in operation 413, transmit the rendered virtual reality object 900a, or second virtual reality object 900b located in the virtual reality space 900c, to the wearable device 106. The wearable device 106 connected with the external device 104 can output the first virtual reality object 900a, or the second virtual reality object 900b located in the virtual reality space 900c, through a display. For example, in response to the wearable device 106 outputting the first virtual reality object 900a, the second user 801 who wears the wearable device 106 can view the first virtual reality object 900a corresponding to the first user 800 through the display. In another example, in response to the wearable device 106 outputting the second virtual reality object 900b located in the virtual realty space 900c by the occurrence of the specified event, the second user 801 who wears the wearable device 106 can view the second virtual reality object 900b located in the virtual reality space 900c which includes the information on the peripheral space around the first user 800 and the location of the first user 800 in the peripheral space.

In an embodiment, that the wearable device 106 outputs the first virtual reality object 900a through the display can be a first mode (e.g., a face to face mode) below.

In an embodiment, that the wearable device 106 outputs the second virtual realty object 900b located in the virtual reality space 900c through the display can be a second mode (e.g., a miniature mode) below.

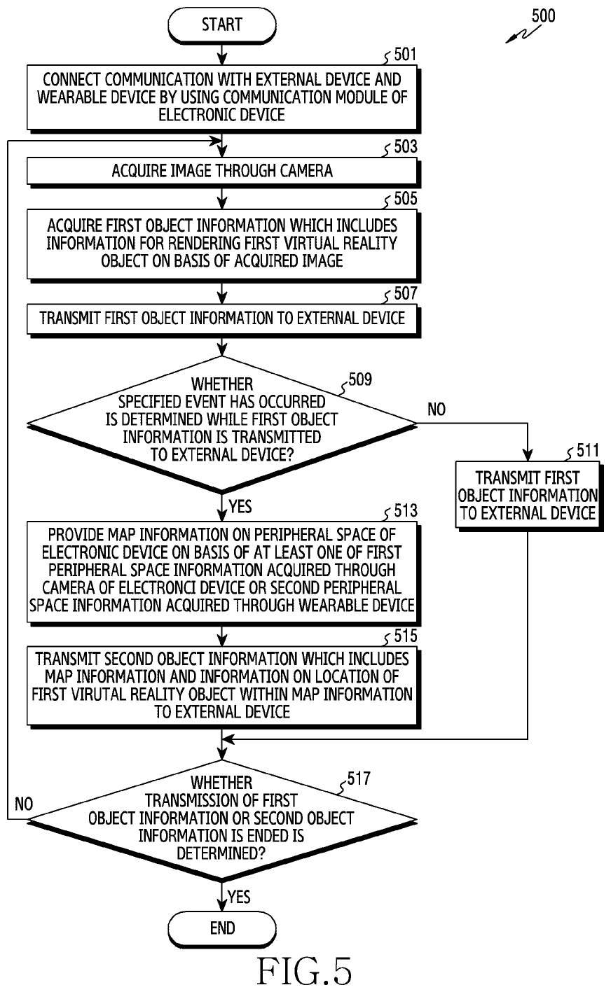

FIG. 5 is a flowchart 500 for explaining the electronic device 100 offering a virtual reality object according to an embodiment.

In an embodiment below, respective operations can be performed in sequence as well, but are not necessarily performed in sequence. For example, the order of the respective operations can be changed as well, and at least two operations can be performed in parallel as well.

According to an embodiment, the electronic device 100 (e.g., the processor 120 of FIG. 3) can, in operation 501, connect communication with the external device 104 and/or the wearable device 102 using the communication module 190.

According to an embodiment, the electronic device 100 (e.g., the processor 120 of FIG. 3) can, in operation 503, acquire an image using the camera 181.

According to an embodiment, the electronic device 100 (e.g., the processor 120) can, in operation 505, acquire first object information which includes information for rendering the first virtual reality object 900a, based on the image acquired through the camera 181.

According to an embodiment, the electronic device 100 (e.g., the processor 120 of FIG. 3) can, in operation 507, transmit the first object information to the external device 104.

According to an embodiment, the electronic device 100 (e.g., the processor 120 of FIG. 3) can, in operation 509, determine whether a specified event has occurred while the first object information is transmitted to the external device 104. For example, in response to an object corresponding to the first object information not being obtained within the image acquired through the camera 181, the electronic device 100 can determine that the specified event has occurred.

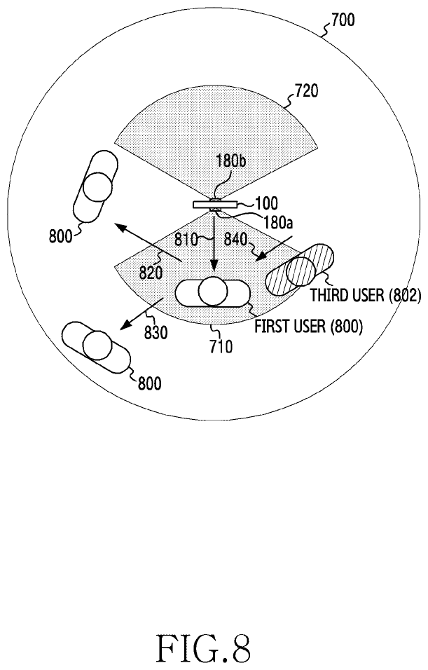

In an embodiment, a description of the specified event is made in detail with reference to FIG. 8.

According to an embodiment, in response to the specified event not having occurred, the electronic device 100 (e.g., the processor 120 of FIG. 3) can, in operation 511, transmit the first object information to the external device 104.

According to an embodiment, in response to the specified event occurring, the electronic device 100 (e.g., the processor 120 of FIG. 3) can, in operation 513, acquire the map information on a peripheral environment of the electronic device 100 based on at least one of the first peripheral space information acquired through the camera 181 or the second peripheral space information acquired through the wearable device 102.

In an example, the electronic device 100 can acquire the first peripheral space information using information on an object located in a third region, acquired through the rear camera 180b.

According to an embodiment, in response to the specified event occurring, the electronic device 100 (e.g., the processor 120 of FIG. 3) can, in operation 515, transmit second object information which includes map information and information on a location of a first virtual reality object within the map information, to the external device 104. For example, the electronic device 100 can determine that the specified event has occurred, because the object corresponding to the first object information is not obtained within the image acquired through the camera 181. In this case, because the first user 800 escapes a range of view angle of the camera 181, the electronic device 100 cannot acquire an image which includes an object corresponding to the first user 800 and information tracking a portion of a body of the first user 800, using the camera 181. The electronic device 100 can transmit the second object information which includes the map information and the information on the location of the first virtual reality object 900a within the map information, to the external deice 104.

According to an embodiment, the electronic device 100 (e.g., the processor 120 of FIG. 3) can, in operation 517, determine whether the transmission of the first object information and/or the second object information is completed. In an example, in response to the first user 800 taking off the worn wearable device 102 and/or in response to the second user 801 taking off the worn wearable device 106, the electronic device 100 can recognize it as the end of a virtual video conference and stop the transmission of the first object information and/or the second object information. In another example, in response to the first user 800 inputting a signal of ending the virtual conference through the display of the electronic device 100, the electronic device 100 can stop the transmission of the first object information and/or the second object information.

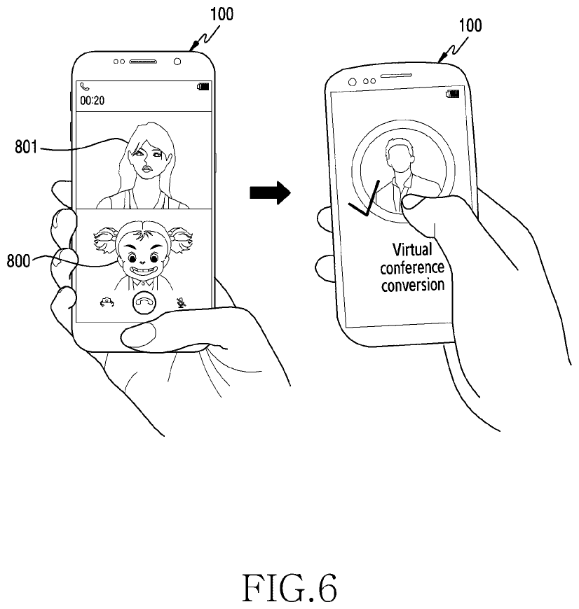

FIG. 6 illustrates a screen of processing conversion from a video call function of the electronic device 100 to a three-dimension virtual video conference function according to an embodiment.

According to an embodiment, the electronic device 100 can execute an app for performing a virtual video conference function in order to proceed with a three-dimension virtual video conference. In an example, while performing a video call using the electronic device 100, the first user 800 can convert the video call into the virtual video conference which uses a virtual reality service. In an example, in response to recognizing the wearable device 102 worn by the first user 800, or receiving an input through a hardware key (e.g., an exclusive hardware key) or a displayed soft key, the electronic device 100 can execute the app for performing the virtual video conference function. In an example, the electronic device 100 can display an icon corresponding to the app for performing the virtual video conference function, on a display.

FIG. 7 illustrates a region capable of tracking using the electronic device 100 and the wearable device 102 according to an example embodiment.

Referring to FIG. 7, the first user 800 can proceed with a virtual video conference with the second user 801 who is in another space, using the electronic device 100 and the wearable device 102, in a space 700 to which the first user 800 who uses a virtual reality service belongs.

In an example embodiment, in response to the electronic device 100 (e.g., a mobile device including the processor 120 of FIG. 3) executing a function including the virtual reality service, the electronic device 100 can acquire an image using the camera 181 (which may include camera(s) 180a and/or 180b). In an example, the image can be acquired through the front camera 180a and/or rear camera 180b of the camera 181. In an example, the image can include an object corresponding to the first user 800 wearing the wearable device 102 which is in a tracking region 710 of the front camera 180a and/or a tracking region 720 of the rear camera 180b. Also, the image can include information on a movement (e.g., a facial look, a movement of a head and/or a hand motion movement) obtained by tracking, by the camera 181, a portion of a body of the first user 800. In an embodiment, the electronic device 100 can acquire first object information which includes information for rendering by a first virtual reality object (e.g., the first virtual reality object 900a of FIG. 9A) corresponding to the first user 800 based on the image.

In an example embodiment, the first peripheral space information can be acquired through the camera 181 of the electronic device 100. For example, the electronic device 100 can acquire the first peripheral space information which includes information on a peripheral space around the electronic device 100 using the front camera 180a and/or the rear camera 180b.

In an example, the wearable device 102 can acquire the second peripheral space information using the camera 320 (e.g., see camera 320 of wearable device 102 in FIG. 3). In an example, it can include the second peripheral space information which includes information on a peripheral space around the first user 800 wearing the wearable device 102, which is within a tracking region 730 of the wearable device 102. In an example, the second peripheral space information can include information on a region included in the first peripheral space information.

FIG. 8 is a diagram illustrating a state of the first user 800 and the occurrence of a specified event dependent on this according to various example embodiments.

Referring to FIG. 8, various location states of the first user 800 who participates in a three-dimension virtual conference are illustrated.

In an example embodiment, a first state 810 of the first user 800 is a state in which an upper half of a body of the first user 800 who wears the wearable device 102 is located within a range of view angle of the camera 181 of the electronic device 100. In an example, in the first state 810 of the first user 800, the camera 181 (e.g., 180a and/or 180b) of the electronic device 100 can track a movement of the upper half of the body of the first user 800. The electronic device 100 can acquire an image which includes an object corresponding to the first user 800 and information tracking a portion (e.g., the upper half of the body, face, and hands of the first user 800) of the body of the first user 800, using the camera 181. The electronic device 100 can acquire first object information which includes information for rendering the first virtual reality object 900a, based on the image. In an example, the electronic device 100 can transmit the first object information to the external device 104 using the communication module 190.

Below, motions 820 to 840 are states representing embodiments of a specified event.

In an example embodiment, a second state 820 of the first user 800 can be a state in which, in the first state 810, the first user 800 escapes the range of view angle of the camera 181 of the electronic device 100. In an example, in response to the first user 800 moving and escaping the range of view angle of the camera 181, the object corresponding to the first user 800 may not be obtained within the image acquired through the camera 181. In an example, the electronic device 100 can be difficult to acquire an image which includes information on the object corresponding to the first user 800 and information tracking a movement of the first user 800 through the camera 181. In response to the object corresponding to the first user 800 not being obtained within the image acquired through the camera 181, the electronic device 100 can determine that the specified event has occurred.

In an example embodiment, a third state 830 of the first user 800 can be a state in which, in the first state 810, the first user 800 gets back and the whole body of the first user 800 is obtained in the range of view angle of the camera 181 in the image. In an example, as the first user 800 moves and gets back, an object corresponding to the upper half or more of the body of the first user 800 can be obtained within the image. In response to an object associated with the object corresponding to the first object information being obtained besides the object corresponding to the first object information, the electronic device 100 can determine that the specified event has occurred.

In an example embodiment, a fourth state 840 of the first user 800 can be a state in which the third user 802 appears within the range of view angle of the camera 181, in the first state 810 corresponding to the state in which the upper half of the body of the first user 800 who wears the wearable device 102 is located within the range of view angle of the camera 181 of the electronic device 100. In an example, in response to the third user 802 appearing within the range of view angle of the camera 181, an object corresponding to the third user 802 can be obtained within the image acquired through the camera 181. The electronic device 100 can identify the number of objects corresponding to the first virtual reality object 900a recognized within the image, and in response to the number of the recognized objects being plural, determine that the specified event has occurred. In another example, in response to the number of wearable devices connecting with the electronic device 100 using the communication module 190 being plural, the electronic device 100 can determine that the specified event has occurred.

In an example embodiment, the electronic device 100 can determine that the specified event has occurred, and in response to the occurrence of the specified event, can transmit second object information which includes map information and information on a location of the first virtual reality object 900a within the map information, to the external device 104. In an example, even when the specified event does not occur, the electronic device 100 can transmit the second object information which includes the map information and the information on the location of the first virtual reality object 900a within the map information, to the external device 104, by an input of the first user 800.

FIG. 9A illustrates an image which is acquired using the electronic device 100 in a first state (e.g., the first state 410 of FIG. 8) of the first user 800 according to an example embodiment.

Referring to FIG. 9A, the first user 800 who wears the wearable device 102 can be located in a range of view angle of the camera 181. In an example, the electronic device 100 can acquire the image which includes an object corresponding to the first user 800 using the camera 181. In an example, the electronic device 100 can acquire the image which includes information on a movement (e.g., a facial look change and/or an upper half movement) obtained by tracking a portion of a body of the first user 800 using the camera 181. The electronic device 100 can acquire first object information for rendering the first virtual reality object 900a based on the image.

FIG. 9B illustrates a rendered object which is offered through the wearable device 106 according to an example embodiment.

FIG. 9B illustrates the rendered object outputted through a display of the wearable device 106 based on the acquired image of FIG. 9A.

Referring to FIG. 9B, the second user 801 who wears the wearable device 106 can view a screen of synthesizing the first virtual reality object 900a in a space of the second user 801 through the wearable device 106.

In an embodiment, the external device 104 can render the first virtual reality object 900a based on the first object information received from the electronic device 100. In another example, the electronic device 100 can render the first virtual reality object 900a based on the first object information. The electronic device 100 can transmit data on the rendered first virtual reality object 900a to the external device 104. In another example, the wearable device 106 connected with the external device 104 can render the first virtual reality object 900a based on the first object information received from the external device 104.

In an embodiment, the external device 104 can render a virtual image corresponding to information on a facial look included in the received first object information, or render an image corresponding to information on a gesture included in the first object information. The first virtual reality object 900a can reflect an object corresponding to an upper half of a body of the first user 800 and a movement (e.g., a look change, a hand motion change, and/or a head movement) of the first user 800 on the object corresponding to the upper half of the body of the first user 800.

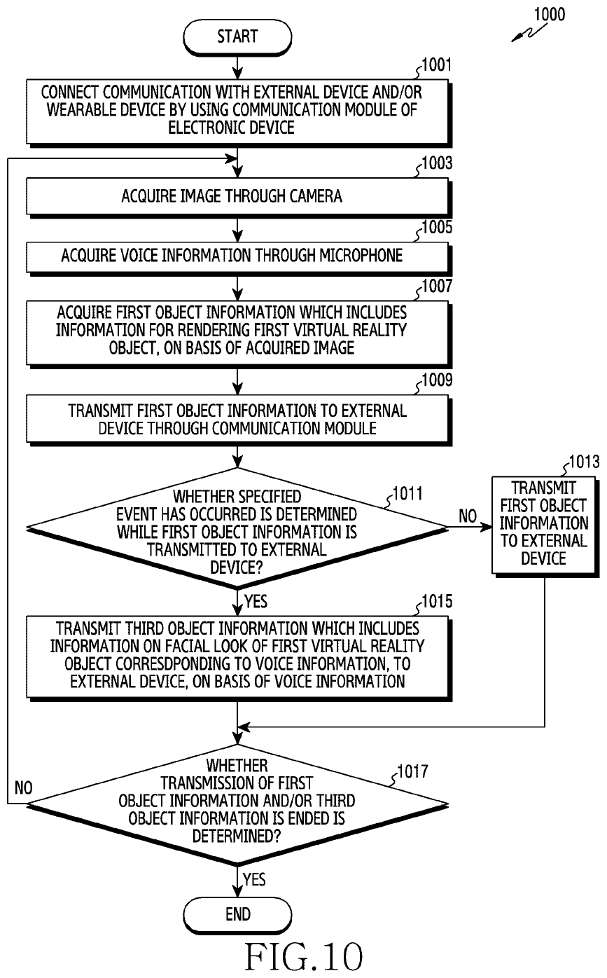

FIG. 10 is a flowchart 1000 for explaining an electronic device offering virtual reality contents according to an example embodiment.

Referring to FIG. 10, in response to a specified event having occurred, third object information can be transmitted.

According to an embodiment, the electronic device 100 (e.g., the processor 120 of FIG. 3) can, in operation 1001, connect communication with the external device 104 and/or the wearable device 102 using the communication module 190.

According to an embodiment, the electronic device 100 (e.g., the processor 120 of FIG. 3) can, in operation 1003, acquire an image using the camera 181.

According to an embodiment, the electronic device 100 (e.g., the processor 120 of FIG. 3) can, in operation 1005, acquire voice information through a microphone (e.g., the input module 150 of FIG. 1).

According to an embodiment, the electronic device 100 (e.g., the processor 120 of FIG. 3) can, in operation 1007, acquire first object information which includes information for rendering a first virtual reality object (e.g., the first virtual reality object 900a of FIG. 9B), based on the acquired image.

According to an embodiment, the electronic device 100 (e.g., the processor 120 of FIG. 3) can, in operation 1009, transmit the first object information to the external device 104 through the communication module 190.

According to an embodiment, the electronic device 100 (e.g., the processor 120 of FIG. 3) can, in operation 1011, determine whether the specified event has occurred while the first object information is transmitted to the external device 104.

According to an embodiment, in response to the specified event not having occurred, the electronic device 100 (e.g., the processor 120 of FIG. 3) can, in operation 1013, transmit the first object information to the external device 104.

According to an embodiment, in response to the specified event occurring, the electronic device 100 (e.g., the processor 120 of FIG. 3) can, in operation 1015, transmit the third object information which includes information on a facial look of the first virtual reality object 900a corresponding to the voice information, to the external device 104, based on the voice information.

According to an embodiment, the electronic device 100 (e.g., the processor 120 of FIG. 3) can, in operation 1017, determine whether the transmission of the first object information and/or the third object information is completed. In an example, in response to the first user 800 taking off the worn wearable device 102 and/or in response to the second user 801 taking off the worn wearable device 106, the electronic device 100 can recognize it as a virtual video conference end signal and stop the transmission of the first object information and/or the third object information. In another example, in response to the first user 800 inputting the virtual conference end signal through the display of the electronic device 100, the electronic device 100 can stop the transmission of the first object information and/or the third object information.

FIG. 11A illustrates an image which is acquired using the electronic device 100 in a second state (e.g., the second state 820 of FIG. 8) of the first user 800 according to an example embodiment.

Referring to FIG. 11A, the second state 820 of the first user 800 can be a state in which the first user 800 moves in the first state 810 and escapes a range of view angle of the camera 181. An object corresponding to the first user 800 may not be obtained within the image. In response to an object corresponding to first object information not being obtained within the image, the electronic device 100 can determine that the specified event has occurred.

FIG. 11B illustrates a rendered object which is offered through the wearable device 106 according to an example embodiment.

Referring to FIG. 11B, in response to the electronic device 100 determining that the specified event has occurred in that the object corresponding to the first object information is not obtained within the image in accordance with FIG. 11A, the wearable device 106 can offer the second virtual reality object 900b located in the virtual reality space 900c, rendered based on second object information.

In an embodiment, in response to the first user 800 moving in the first state 810 and escaping the range of view angle of the camera 181 of the electronic device 100, the electronic device 100 can determine that the specified event has occurred and transmit the second object information to the external device 104. Here, the second object information can include map information and information on a location of a first virtual reality object (e.g., the first virtual reality object 900a of FIG. 9B) within the map information.

In an embodiment, the external device 104 can render the second virtual reality object 900b located in the virtual reality space 900c, based on the received second object information. For example, in response to the first user 800 escaping the range of view angle of the camera 181 and being located, the electronic device 100 can determine that the specified event has occurred, and transmit the second object information to the external device 104. The external device 104 can render the virtual reality space 900c including information on a peripheral space in which the first user 800 is located, by a 3D model, based on the received second object information. The external device 104 can render the second virtual reality object 900b corresponding to the first user 800 to the virtual reality space 900c, based on the second object information including information on a location of the first user 800, in the virtual reality space 900c rendered by the 3D model. In an example, the external device 104 can render the virtual reality space 900c by the 3D model in a rectangular parallelepiped (e.g., simple box) or cylinder form.

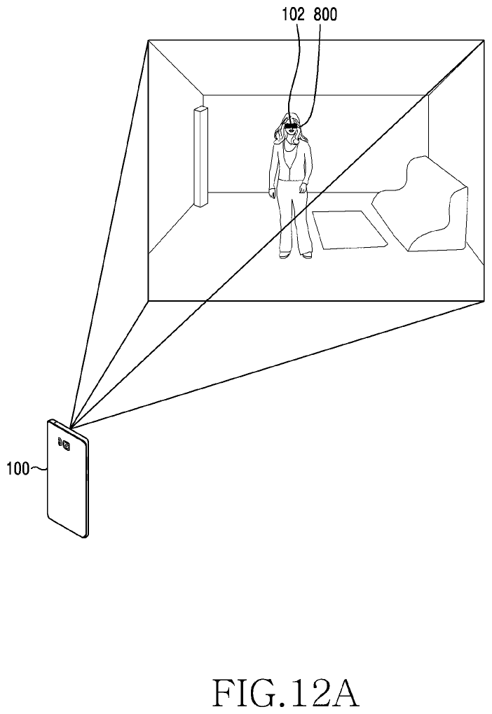

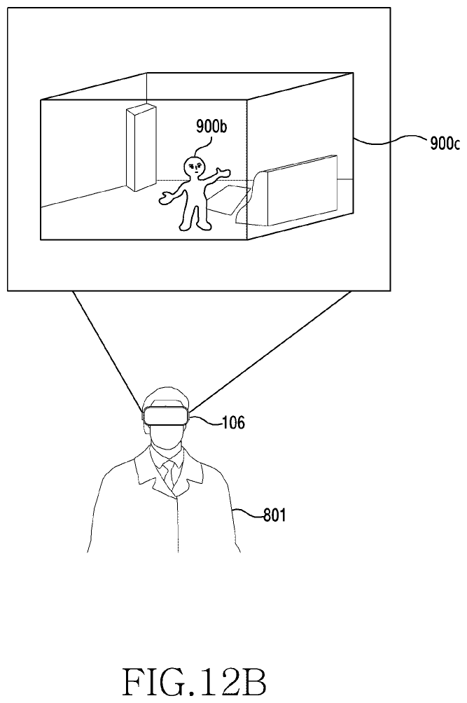

FIG. 12A illustrates an image which is acquired using the electronic device 100 in a third state (e.g., the third state 830 of FIG. 8) of the first user 800 according to an example embodiment.

Referring to FIG. 12A, the third state 830 of the first user 800 can be a state in which, in the first state 810 being a state in which the upper half of the body of the first user 800 is located in the range of view angle of the camera 181, the first user 800 gets back and the whole body of the first user 800 is obtained in the image in the range of view angle of the camera 181. In response to an object associated with an object corresponding to first object information being obtained, the electronic device 100 can determine that the specified event has occurred.

FIG. 12B illustrates a rendered object which is offered through the wearable device 106 according to an example embodiment.

Referring to FIG. 12B, in response to the electronic device 100 determining that the specified event has occurred in that the object associated with the object corresponding to the first object information is additionally obtained within the image in accordance with FIG. 12A, the wearable device 106 can offer the second virtual reality object 900b located in the virtual reality space 900c based on the second object information.

In an embodiment, in response to the first user 800 getting back and the whole body of the first user 800 being obtained in the image in the range of view angle of the camera 181 (e.g., the third state 830), the electronic device 100 can determine that the specified event has occurred, and transmit the second object information to the external device 104.

In an embodiment, the external device 104 can render the second virtual reality object 900b located in the virtual reality space 900c, based on the received second object information. For example, in response to the first user 800 getting back in the first state 810 being the state in which the upper half of the body of the first user 800 is located in the range of view angle of the camera 181, and the whole body of the first user 800 being obtained in the image, the electronic device 100 can determine that the specified event has occurred, and transmit the second object information to the external device 104. The external device 104 can render the virtual reality space 900c including information on a peripheral environment in which the first user 800 is located, by a 3D model, based on the second object information. The external device 104 can render the second virtual reality object 900b corresponding to the whole body of the first user 800 to the virtual reality space 900c, based on the second object information including information on a location of the first user 800, in the virtual reality space 900c rendered by the 3D model. In an example, the external device 104 can render the virtual reality space 900c by the 3D model in a rectangular parallelepiped (e.g., simple box) or cylinder form.

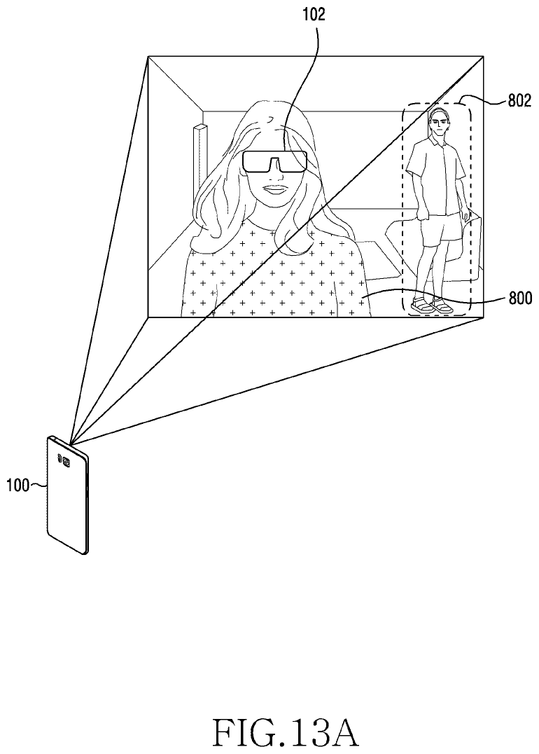

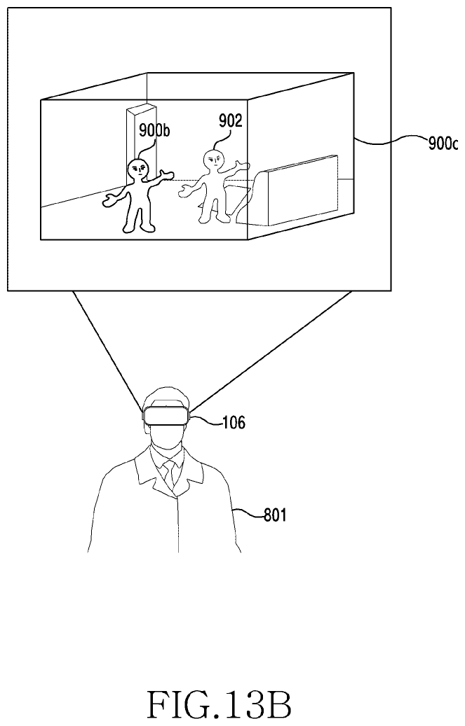

FIG. 13A illustrates an image which is acquired using the electronic device 100 in a fourth state (e.g., the fourth state 840 of FIG. 8) of the first user 800 according to an example embodiment.

Referring to FIG. 13A, the fourth state 840 of the first user 800 can be a state in which the third user 802 appears in a range of view angle of the camera 181 in the first state 810 being a state in which the upper half of the body of the first user 800 is located in the range of view angle of the camera 181. In response to the number of objects recognized in the image being plural, the electronic device 100 can determine that the specified event has occurred.

FIG. 13B illustrates a rendered object which is offered through the wearable device 106 according to an example embodiment.

Referring to FIG. 13B, in response to the specified event having occurred in that the number of objects corresponding to the first virtual reality object 900a recognized in the image is plural in accordance with FIG. 13A, the wearable device 106 can offer the second virtual reality object 900b located in the virtual reality space 900c, rendered based on second object information.

In an embodiment, in response to the third user 802 being in the range of view angle of the camera 181 (e.g., the fourth state 840), the electronic device 100 can determine that the specified event has occurred, and transmit the second object information to the external device 104.

In an embodiment, the external device 104 can render the second virtual reality object 900b located in the virtual reality space 900c, based on the received second object information. For example, in response to the third user 802 being within the range of view angle of the camera 181 in the first state 810 of the first user 800, the electronic device 100 can determine that the specified event has occurred, and transmit the second object information to the external device 104. The external device 104 can render the virtual reality space 900c including information on a peripheral environment in which the first user 800 is located, by a 3D model, based on the received second object information. The external device 104 can render the second virtual reality object 900b corresponding to the first user 800 to the virtual reality space 900c, based on the second object information including information on a location of the first user, in the virtual reality space 900c rendered by the 3D model. The external device 104 can render a third virtual reality object 902 to the virtual reality space 900c, based on the second object information including information on the third user 802 acquired using the camera 181.

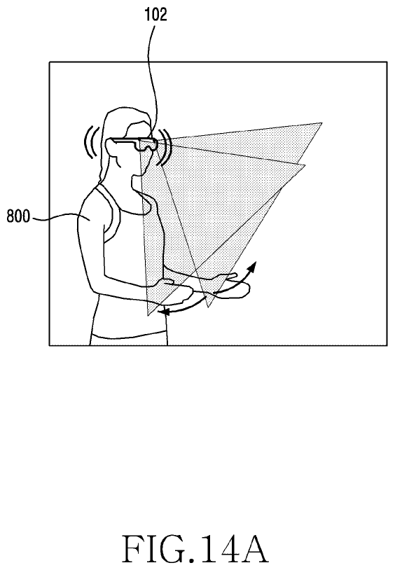

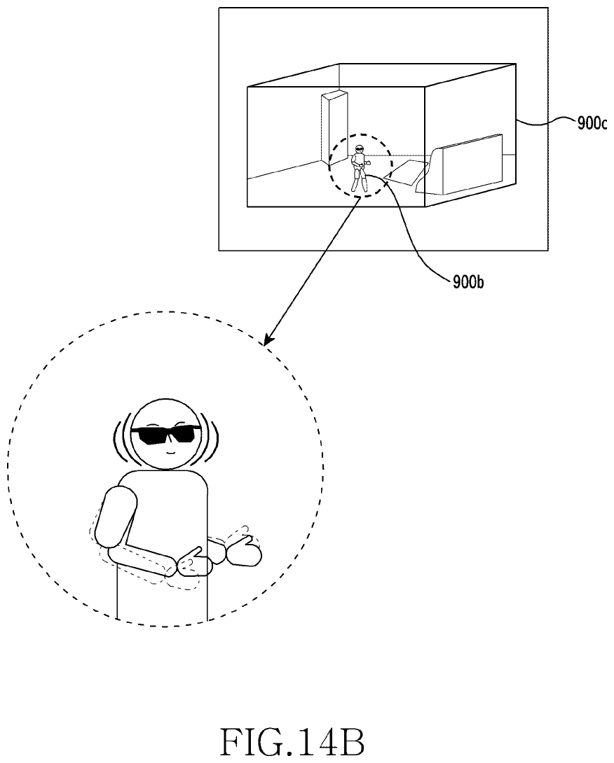

FIG. 14A illustrates a tracking state of a portion of a body of the first user 800 which uses the wearable device 102 according to an example embodiment.

Referring to FIG. 14A, the wearable device 102 can obtain information on a head movement, and/or information on a hand motion movement, of the first user 800 who wears the wearable device 102, using the camera 320.

In an embodiment, second object information can include the information on the head movement and/or hand motion of the first user 800 who wears the wearable device 102, acquired using the wearable device 102.

FIG. 14B illustrates a rendered object which is offered through the wearable device 106 according to an example embodiment.

Referring to FIG. 14B, the wearable device 106 can output the second virtual realty object 900b which reflects the information on the head movement, and/or the information on the hand motion movement, of the first user 800 who wears the wearable device 102.

In an embodiment, the electronic device 100 can acquire the second object information which includes the information on the head movement and/or hand motion movement of the first user 800 who wears the wearable device 102, acquired through the wearable device 102.

In an embodiment, the external device 104 can render the second virtual reality object 900b based on the second object information.

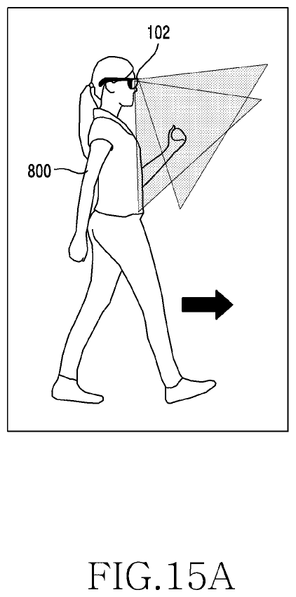

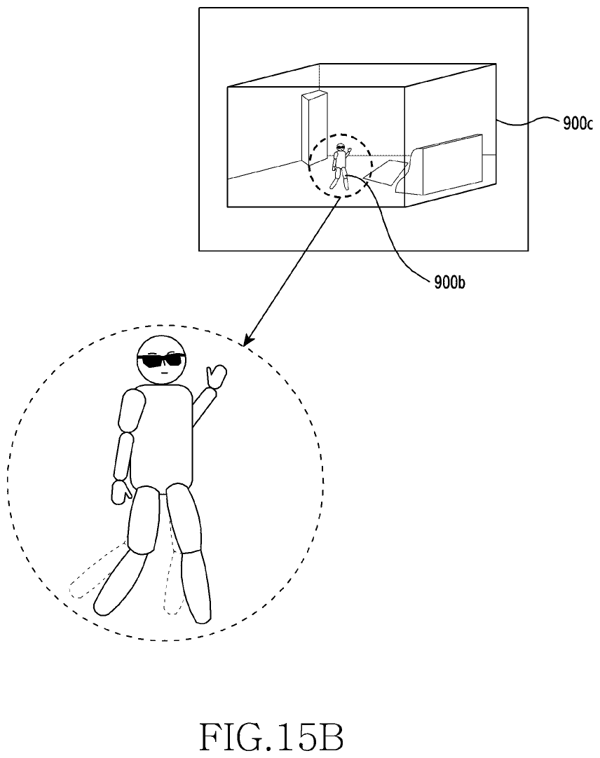

FIG. 15A illustrates a tracking state of a portion of a body of the first user 800 which uses the wearable device 102 according to an example embodiment.

Referring to FIG. 15A, the wearable device 102 can obtain information on a leg motion movement of the first user 800 who wears the wearable device 102, using the camera 320 (e.g., see camera 320 in FIG. 3).

In an embodiment, second object information can include the information on the leg motion movement of the first user 800 who wears the wearable device 102, acquired using the wearable device 102.

FIG. 15B illustrates a rendered object which is offered through the wearable device 106 according to an example embodiment.

Referring to FIG. 15B, the wearable device 106 can output the second virtual realty object 900b which reflects the information on the leg motion movement of the first user 800 who wears the wearable device 102.

In an embodiment, the electronic device 100 can acquire the second object information which includes the information on the leg movement of the first user 800 who wears the wearable device 102, acquired through the wearable device 102.

In an embodiment, the external device 104 can render the second virtual reality object 900b based on the second object information.

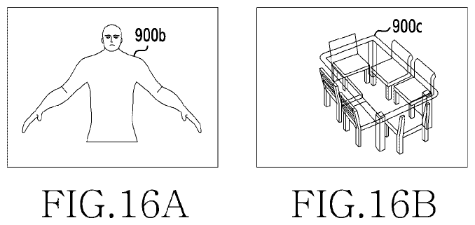

FIG. 16 illustrates an example of a virtual reality object which is offered through the wearable device 106 according to an example embodiment.

Referring to FIG. 16A, second object information can exclude at least a portion of information on a facial look of an object corresponding to first object information, information on a head movement of the object, information on a hand motion movement, and/or information on a leg motion movement. The external device 104 can render the second virtual reality object 900b based on the second object information of which the at least portion is missed. In an example, the wearable device 106 can output the second virtual reality object 900b in a frame form. The frame form can include a simple shape of the object.

Referring to FIG. 16B, the second object information can include map information and information on the first virtual reality object 900a associated with the map information. In an example, the second object information can include the map information excluding information on a location of the first virtual reality object 900a within the map information. In an example, the wearable device 106 can output the virtual reality space 900c from which the second virtual reality object 900b is excluded.

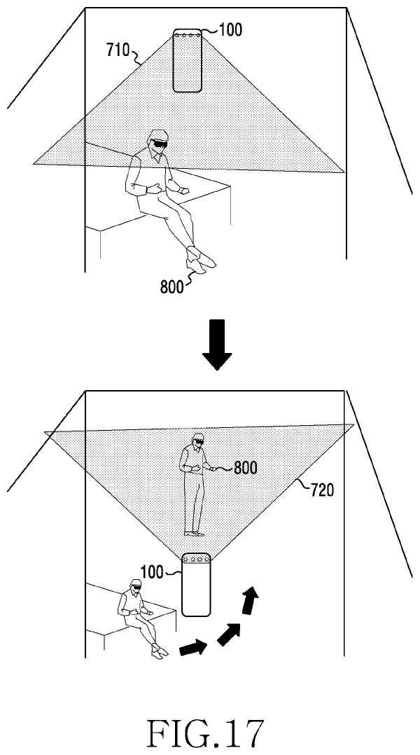

FIG. 17 illustrates a condition in which the first user 800 moves within and without a range of view angle of the camera 181 of the electronic device 100 according to an example embodiment.

Referring to FIG. 17, the electronic device 100 can acquire an image including an object corresponding to the first user 800 who wears the wearable device 102, using the front camera 180a. The electronic device 100 can acquire first object information including information for rendering the first virtual reality object 900a, based on the image. The wearable device 106 can output (e.g., a face to face mode) the first virtual realty object 900a rendered based on the first object information.

In an embodiment, the first user 800 can move out of the tracking region 710 of the front camera 180. In this case, the electronic device 100 can determine that a specified event has occurred. The electronic device 100 can transmit second object information which includes map information and information on a location of the first virtual reality object within the map information, to the external device 104. The wearable device 106 can output (e.g., a miniature mode) the second virtual reality object 900b located in the virtual reality space 900c, rendered based on the second object information.

In an embodiment, the first user 800 can move out of the tracking region 710 of the front camera 180a, and be located in the tracking region 720 of the rear camera 180b. In this case, the electronic device 100 can acquire an image including an object corresponding to the first user 800, using the rear camera 180b. The electronic device 100 can acquire the first object information including information for rendering the first virtual reality object 900a, based on the image. The wearable device 106 can again output (e.g., a face to face mode) the first virtual realty object 900a rendered based on the first object information.

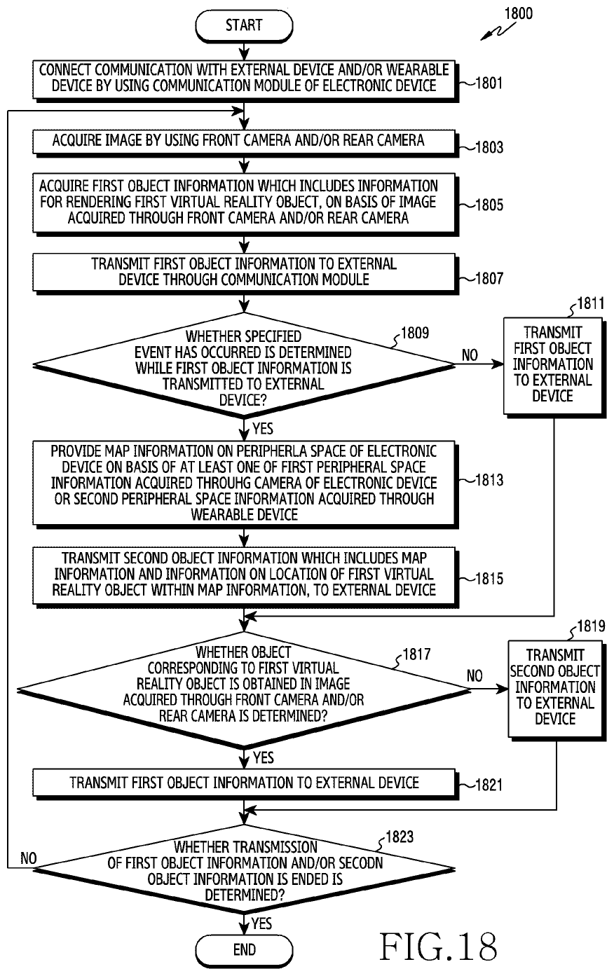

FIG. 18 is a flowchart 1800 for explaining an electronic device offering a virtual reality object according to an example embodiment.

In an embodiment below, respective operations can be performed in sequence as well, but are not necessarily performed in sequence. For example, the order of the respective operations can be changed as well, and at least two operations can be performed in parallel as well.

According to an embodiment, the electronic device 100 (e.g., of or including the processor 120 of FIG. 3) can, in operation 1801, connect communication with the external device 104 and/or the wearable device 102 using the communication module 190.

According to an embodiment, the electronic device 100 (e.g., the processor 120 of FIG. 3) can, in operation 1803, acquire the image using the front camera 180a and/or the rear camera 180b.

In an embodiment, the electronic device 100 (e.g., the processor 120 of FIG. 3) can, in operation 1805, acquire first object information which includes information for rendering the first virtual reality object 900a, based on the image acquired through the front camera 180a and/or the rear camera 180b.

According to an embodiment, the electronic device 100 (e.g., the processor 120 of FIG. 3) can, in operation 1807, transmit the first object information to the external device 104.

According to an embodiment, the electronic device 100 (e.g., the processor 120 of FIG. 3) can, in operation 1809, determine whether the specified event has occurred while the first object information is transmitted to the external device 104.

According to an embodiment, in response to the specified event not having occurred, the electronic device 100 (e.g., the processor 120 of FIG. 3) can, in operation 1811, transmit the first object information to the external device 104.

According to an embodiment, the electronic device 100 (e.g., the processor 120 of FIG. 3) can, in operation 1813, provide map information on a peripheral environment of the electronic device 100 based on at least one of first peripheral space information acquired through the front camera 180a and/or the rear camera 180b or second peripheral space information acquired through the wearable device 102.

In an embodiment, in response to the specified event occurring, the electronic device 100 (e.g., the processor 120 of FIG. 3) can, in operation 1815, transmit second object information which includes the map information and information on a location of the first virtual reality object 900a within the map information, to the external device 104. For example, in response to the first user 800 escaping out of the tracking region 710 of the front camera 180a, and an object corresponding to the first object information not being obtained within the image acquired through the front camera 180a and/or rear camera 180b, the electronic device 100 can determine that the specified event has occurred.

In an embodiment, the electronic device 100 (e.g., the processor 120 of FIG. 3) can, in operation 1817, determine whether the object corresponding to the first virtual reality object 900a is obtained in the image acquired through the front camera 180a and/or rear camera 180b. For example, after escaping out of the tracking region 710 of the front camera 180a, the first user 800 can be located in the tracking region 720 of the rear camera 180b.

According to an embodiment, in response to the object corresponding to the first virtual reality object 900 not being obtained in the image acquired through the front camera 180a and/or rear camera 180b, the electronic device 100 (e.g., the processor 120 of FIG. 3) can, in operation 1819, transmit the second object information to the external device 104.

According to an embodiment, in response to the object corresponding to the first virtual reality object 900a being obtained in the image acquired through the front camera 180a and/or rear camera 180b, the electronic device 100 (e.g., of or including the processor 120 of FIG. 3) can, in operation 1821, transmit the first object information to the external device 104.

According to an embodiment, the electronic device 100 (e.g., of or including the processor 120 of FIG. 3) can, in operation 1823, determine whether the transmission of the first object information and/or the second object information is completed. In an example, in response to the first user 800 taking off the worn wearable device 102 and/or in response to the second user 801 taking off the worn wearable device 106, the electronic device 100 can recognize it as the end of a virtual video conference and stop the transmission of the first object information and/or the second object information. In another example, in response to the first user 800 inputting a signal of ending the virtual video conference through the display of the electronic device 100, the electronic device 100 can stop the transmission of the first object information and/or the second object information.

In accordance with various embodiments, an electronic device can include a communication module comprising communication circuitry, a camera, and at least one processor operably coupled with the communication module and the camera. The at least one processor can be configured to establish a communication connection with an external device and a wearable device via the communication module, and acquire an image through the camera, and acquire first object information for rendering a first virtual reality object based on at least the image, and transmit the first object information to the external device via the communication module, and while transmitting the first object information to the external device, determine whether a specified event occurs, and acquire map information on a peripheral environment of the electronic device based on at least one of first peripheral space information including information regarding an object located within a first region, acquired using the camera, or second peripheral space information including information regarding an object located within a second region, received from the wearable device, and based on the occurrence of the specified event, transmit second object information which includes the map information and information regarding a location of the first virtual reality object within the map information, to the external device.

In an embodiment, the specified event can include that an object corresponding to the first object information is not obtained within the image acquired through the camera.

In an embodiment, the at least one processor can be configured to identify the number of objects corresponding to the first virtual reality object, based on at least one of the number of objects recognized within the image acquired through the camera or the number of wearable devices connected to the electronic device using the communication module, and determine whether the specified event occurs based on whether the number of the first virtual reality objects is plural.

In an embodiment, the at least one processor can be configured to additionally obtain an object associated with an object corresponding to the first object information, besides the object corresponding to the first object information recognized within the image acquired through the camera, and determine whether the specified event occurs based on the obtaining of the associated object.

In an embodiment, the at least one processor can be configured to acquire map information on a region not included in the first peripheral space information, based on the second peripheral space information received from the wearable device.

In an embodiment, the electronic device can further include a rear camera disposed in a surface opposite to a surface where the camera is disposed, and the at least one processor can be configured to acquire the first peripheral space information by further using information on an object located within a third region, acquired through the rear camera, and determine whether the specified event occurs based on whether an object corresponding to the first object information is obtained within the image acquired using the camera.

In an embodiment, the at least one processor can configured to acquire the first object information including information for rendering the first virtual reality object within the image acquired using the camera, and transmit the first object information to the external device, and while transmitting the first object information to the external device, in response to the object corresponding to the first object information not being obtained within the image acquired through the camera, determine that the specified event occurs and transmit the second object information to the external device, and while transmitting the second object information to the external device, in response to an object corresponding to the first virtual reality object being obtained within an image acquired through the rear camera, transmit the first object information to the external device.

In an embodiment, the second object information can include at least one of coordinate information indicating the location of the first virtual reality object within the map information, or information on a relative location between a peripheral space object included in the map information and the first virtual reality object.

In an embodiment, the first object information can include at least one of information on a facial look of an object corresponding to the first virtual reality object, information on a movement of a head of the object, information on a hand motion, or information on a leg motion.

In an embodiment, the second object information may not include at least a portion of the information included in the first object information.

In accordance with various embodiments, an operation method of an electronic device can include establishing a communication connection with an external device and a wearable device using a communication module, and acquiring an image through a camera, and acquiring first object information for rendering a first virtual reality object based on the image, and transmitting the first object information to the external device through the communication module, and while transmitting the first object information to the external device, determining whether a specified event occurs, and acquiring map information on a peripheral environment of the electronic device based on at least one of first peripheral space information including information on an object located within a first region, acquired using the camera, or second peripheral space information including information on an object located within a second region, received from the wearable device, and based on the occurrence of the specified event, transmitting second object information which includes the map information and information on a location of the first virtual reality object within the map information, to the external device.

In an embodiment, the specified event can include that an object corresponding to the first object information is not obtained within the image acquired through the camera.

In an embodiment, the method can further include identifying the number of objects corresponding to the first virtual reality object, based on at least one of the number of objects recognized within the image acquired through the camera or the number of wearable devices connected to the electronic device, and determining whether the specified event occurs based on whether the number of the first virtual reality objects is plural.

In an embodiment, the second object information can include at least one of coordinate information indicating the location of the first virtual reality object within the map information, or information on a relative location between a peripheral space object included in the map information and the first virtual reality object.

In an embodiment, the first object information can include at least one of information on a facial look of an object corresponding to the first virtual reality object, information on a movement of a head of the object, information on a hand motion, or information on a leg motion.

In an embodiment, the second object information may not include at least a portion of the information included in the first object information.

In accordance with various embodiments, the electronic device can include a communication module, a camera, and at least one processor operably coupled with the communication module and the camera. The at least one processor can be configured to establish a communication connection with an external device and a wearable device using the communication module, and in response to receiving first object information from the external device, render a first virtual reality object based on the first object information for rendering the first virtual reality object, and after receiving the first object information, in response to receiving second object information from the external device, render a virtual reality space and a second virtual reality object, based on the second object information which includes map information and information on a location of the first virtual reality object within the map information, and in response to a specified event not occurring, transmit the rendered first virtual reality object to the wearable device, and in response to the specified event occurring, transmit the rendered virtual reality space and second virtual reality object to the wearable device.

In an embodiment, the specified event can include that an object corresponding to the first object information is not obtained within an image acquired through a camera of the external device.

In an embodiment, the second object information can include at least one of coordinate information indicating the location of the first virtual reality object within the map information, or information on a relative location between a peripheral space object included in the map information and the first virtual reality object.

In an embodiment, the first object information can include at least one of information on a facial look of an object corresponding to the first virtual reality object, information on a movement of a head of the object, information on a hand motion, or information on a leg motion.

1. An electronic device comprising:
a communication module comprising communication circuitry;
a camera; and
at least one processor operably coupled with the communication module and the camera,
wherein the at least one processor is configured to:
establish a communication connection with an external device and a wearable device via the communication module;
acquire an image through the camera;
acquire first object information for rendering a first virtual reality object based on at least the image;
control to transmit the first object information to the external device via the communication module;
while transmitting the first object information to the external device, determine whether a specified event occurs;
acquire map information regarding a peripheral environment of the electronic device based on at least one of first peripheral space information comprising information regarding an object located within a first region, acquired via the camera, or second peripheral space information comprising information regarding an object located within a second region, received from the wearable device; and
based on the occurrence of the specified event, control to transmit second object information which comprises the map information and information regarding a location of the first virtual reality object within the map information, to the external device.

2. The electronic device of claim 1, wherein the specified event comprises that an object corresponding to the first object information is not obtained within the image acquired through the camera.

3. The electronic device of claim 1, wherein the at least one processor is configured to:
identify the number of objects corresponding to the first virtual reality object, based on at least one of the number of objects recognized within the image acquired through the camera or the number of wearable devices connected to the electronic device by using the communication module; and
determine whether the specified event occurs based on at least whether the number of the first virtual reality objects is plural.

4. The electronic device of claim 1, wherein the at least one processor is configured to:
additionally obtain an object associated with an object corresponding to the first object information, besides the object corresponding to the first object information recognized within the image acquired through the camera; and
determine whether the specified event occurs based on at least obtaining of the associated object.

5. The electronic device of claim 1, wherein the at least one processor is configured to acquire map information on a region not comprised in the first peripheral space information, based on at least the second peripheral space information received from the wearable device.

6. The electronic device of claim 1, further comprising a rear camera disposed in a surface opposite to a surface where the camera is disposed,
wherein the at least one processor is configured to:
acquire the first peripheral space information using information on an object located within a third region, acquired through the rear camera; and
determine whether the specified event occurs based on at least whether an object corresponding to the first object information is obtained within the image acquired using the camera.

7. The electronic device of claim 6, wherein the at least one processor is configured to:
acquire the first object information for rendering the first virtual reality object within the image acquired using the camera;
transmit the first object information to the external device;
while transmitting the first object information to the external device, in response to the object corresponding to the first object information not being obtained within the image acquired through the camera, determine that the specified event occurs and transmit the second object information to the external device; and
while transmitting the second object information to the external device, in response to an object corresponding to the first virtual reality object being obtained within an image acquired through the rear camera, transmit the first object information to the external device.

8. The electronic device of claim 1, wherein the second object information comprises at least one of coordinate information indicating the location of the first virtual reality object within the map information, or information regarding a relative location between a peripheral space object comprised in the map information and the first virtual reality object.

9. The electronic device of claim 1, wherein the first object information comprises at least one of information regarding a facial look of an object corresponding to the first virtual reality object, information regarding a movement of a head of the object, information regarding a hand motion, or information regarding a leg motion.

10. The electronic device of claim 9, wherein the second object information does not comprise at least a portion of the information comprised in the first object information.

11. An operation method of an electronic device, the method comprising:
establishing a communication connection with an external device and a wearable device using a communication module comprising communication circuitry;
acquiring an image through a camera;
acquiring first object information for rendering a first virtual reality object based on at least the image;
transmitting the first object information to the external device via the communication module;
while transmitting the first object information to the external device, determining whether a specified event occurs;
acquiring map information regarding a peripheral environment of the electronic device based on at least one of first peripheral space information comprising information regarding an object located within a first region, acquired via the camera, or second peripheral space information comprising information regarding an object located within a second region, received from the wearable device; and
based on the occurrence of the specified event, transmitting second object information which comprises the map information and information regarding a location of the first virtual reality object within the map information, to the external device.

12. The method of claim 11, wherein the specified event comprises that an object corresponding to the first object information is not obtained within the image acquired through the camera.

13. The method of claim 12, further comprising:
identifying the number of objects corresponding to the first virtual reality object, based on at least one of the number of objects recognized within the image acquired through the camera or the number of wearable devices connected to the electronic device; and
determining whether the specified event occurs based on at least whether the number of the first virtual reality objects is plural.

14. The method of claim 11, wherein the second object information comprises at least one of coordinate information indicating the location of the first virtual reality object within the map information, or information regarding a relative location between a peripheral space object comprised in the map information and the first virtual reality object.

15. The method of claim 11, wherein the first object information comprises at least one of information regarding a facial look of an object corresponding to the first virtual reality object, information regarding a movement of a head of the object, information regarding a hand motion, or information regarding a leg motion.

16. The method of claim 15, wherein the second object information does not comprise at least a portion of the information comprised in the first object information.

17. An electronic device comprising:
a communication module comprising communication circuitry;
a camera; and
at least one processor operably coupled with the communication module and the camera,
wherein the at least one processor is configured to:
establish a communication connection with an external device and a wearable device via the communication module;
in response to at least receiving first object information from the external device, render a first virtual reality object based on at least the first object information for rendering the first virtual reality object;
after receiving the first object information, in response to receiving second object information from the external device, render a virtual reality space and a second virtual reality object, based on at least the second object information which comprises map information and information regarding a location of the first virtual reality object within the map information;
in response to at least a specified event not occurring, transmit the rendered first virtual reality object to the wearable device; and
in response to at least the specified event occurring, transmit the rendered virtual reality space and second virtual reality object to the wearable device.

18. The electronic device of claim 17, wherein the specified event comprises that an object corresponding to the first object information is not obtained within an image acquired through a camera of the external device.

19. The electronic device of claim 17, wherein the second object information comprises at least one of coordinate information indicating the location of the first virtual reality object within the map information, or information regarding a relative location between a peripheral space object comprised in the map information and the first virtual reality object.

20. The electronic device of claim 17, wherein the first object information comprises at least one of information regarding a facial look of an object corresponding to the first virtual reality object, information regarding a movement of a head of the object, information regarding a hand motion, or information regarding a leg motion.
